(19) United States
(12) Patent Application Publication
(10) Pub. No.: US 2011/0119736 A1
(43) Pub. Date: May 19, 2011

(54) APPARATUS AND METHOD FOR PREVENTING CHARGE CAUSED BY UTILIZING APPLICATION IN PORTABLE TERMINAL

(75) Inventors: Sun-Young Maeng, Seoul (KR); Sung-Hoon Cha, Suwon-si (KR)

(73) Assignee: Samsung Electronics Co. Ltd., Suwon-si (KR)

(21) Appl. No.: 12/948,244

(22) Filed: Nov. 17, 2010

(30) Foreign Application Priority Data
Nov. 19, 2009 (KR) 10-2009-0111973

(51) Int. Cl. G06F 21/22

(52) U.S. Cl. 726/3

(57) ABSTRACT

An apparatus and method for determining a function that causes a charging problem and a personal information leakage problem when executing an application are provided. The apparatus includes an application configuration unit for determining and storing function information of the application that performs a network connection, and for providing a network connection function item of the application selected by a user based on the pre-stored function information.

### PRIORITY

This application claims the benefit under 35 U.S.C. §119(a) of a Korean patent application filed on Nov. 19, 2009 in the Korean Intellectual Property Office and assigned Serial No. 10-2009-0111973, the entire disclosure of which is hereby incorporated by reference.

### BACKGROUND OF THE INVENTION

1. Field of the Invention

The present invention relates to a portable terminal for executing a downloaded application. More particularly, the present invention relates to an apparatus and method for determining a function that causes a charging problem and a personal information leakage problem when executing an application and for preventing the occurrence of the charging problem and the personal information leakage problem when executing the application.

2. Description of the Related Art

Recently, with the rapid development of communication technology, a mobile terminal providing wireless voice calls and data exchange is regarded as a personal necessity. Conventional portable terminals have generally been regarded as portable devices providing wireless calls. However, along with technical advances and introduction of the wireless Internet, portable terminals are now used for many purposes in addition to simple telephone calls or scheduling. For example, portable terminals provide a variety of functions to satisfy users' demands, such as games, remote controlling using near field communication, capturing images using a built-in digital camera, and the like.

In addition, an application (e.g., a new game, stock related program, and the like) may be downloaded and installed in the portable terminal via a mobile browser (e.g., WAP), which is a program used to search for various resources on the Internet.

Using such an application, communication with the network can be performed (e.g., ranking information request, good food restaurants, and the like) by network access or by transmission and reception of a short message or a multimedia message in a situation not recognized by a user while executing the application according to the design of the application. In order to determine the function performed using the application (e.g., network access, short message transmission, multimedia transmission, and the like.), the user of the portable terminal has to access a homepage of the developer of the application to refer to an application's descriptions that are arbitrarily written by the developer.

However, if the application is executed when the user of the portable terminal is not aware of the function of the application or when the developer intentionally did not specify corresponding information, the portable terminal may connect to a network undesired by the user and a charge for a corresponding function has to be paid. Additionally, when the portable terminal performs the network access, personal information may be leaked without the user's recognition. The portable terminal provides information of the portable terminal (i.e., user information) to access the network, and thereafter determines whether the network is accessible. In this process, personal information may be leaked without the user's consent.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for determining a function performed when an application is executed in a portable terminal.

Another aspect of the present invention is to provide an apparatus and method for restricting execution of an application based on information on a function performed when the application is executed in a portable terminal.

Another aspect of the present invention is to provide an apparatus and method addressing a charging problem and personal information leakage problem occurring when an application is executed in a portable terminal.

In accordance with an aspect of the present invention, an apparatus for preventing charging caused by the use of an application in a portable terminal is provided. The apparatus includes an application configuration unit for determining and storing function information of the application that performs a network connection, and for providing a network connection function item of the application selected by a user based on the pre-stored function information.

In accordance with another aspect of the present invention, a method for preventing charging caused by the use of an application in a portable terminal is provided. The method includes determining and storing function information of the application that performs a network connection when the application is installed, and providing a network connection function item of an application selected by a user based on the pre-stored function information, after the determining and storing of the function information.

In accordance with another aspect of the present invention, a mobile terminal is provided. The mobile terminal includes a communication unit for communicating with a network, a memory, a controller for controlling execution of a function of an application stored in the mobile terminal based on network function information about the application, and an application configuration unit for installing the application, for identifying the network function information of the application when the application is installed, and for storing the network function information in the memory.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a structure of a portable terminal for determining a function for performing an application according to an exemplary embodiment of the present invention;

FIG. 2 illustrates a process of restricting execution of an application in a portable terminal according to an exemplary embodiment of the present invention;

FIG. 3 is a flowchart illustrating a process of preventing execution of a charging-related function which is performed in an application downloaded and installed in a portable terminal according to an exemplary embodiment of the present invention; and

FIG. 4 is a flowchart illustrating a process of executing an application downloaded and installed in a portable terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention described below relate to an apparatus and method for determining a function performed when an application is executed in a portable terminal and for addressing a charging problem and personal information leakage problem when the application is executed. As used herein, the charging problem denotes a situation where a user is charged for network or other access without the user's knowledge. The personal information leakage problem denotes a situation where the user's personal information is transmitted to another party without the user's knowledge and/or consent.

An application function denotes a function that causes a user's personal information leakage problem or charging problem through a network connection performed in a situation recognized or not recognized by the user when a pre-installed application is executed in the portable terminal The application function may include a network access function, a short message transmission function, a multimedia message transmission function, and the like.

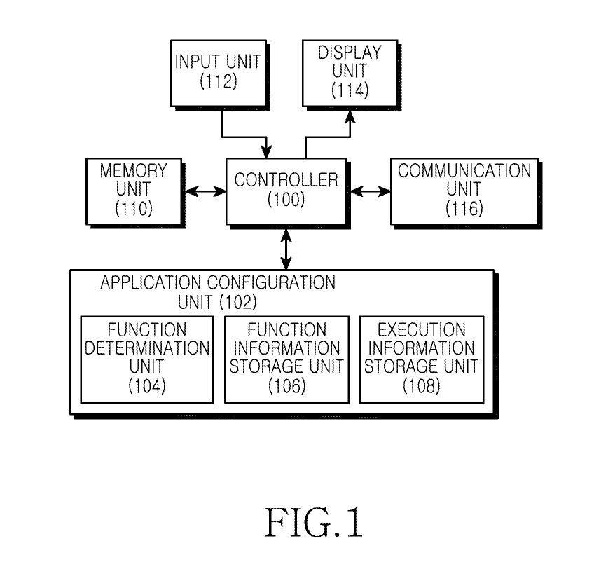

FIG. 1 is a block diagram illustrating a structure of a portable terminal for determining a function for performing an application according to an exemplary embodiment of the present invention.

Referring to FIG. 1, the portable terminal includes a controller 100, an application configuration unit 102, a memory unit 110, an input unit 112, a display unit 114, and a communication unit 116. The application configuration unit 102 includes a function determination unit 104, a function information storage unit 106, and an execution information storage unit 108. The portable terminal may include additional units that are not illustrated here merely for sake of clarity. Similarly, the functionality of two or more of the above units may be integrated into a single component.

The controller 100 provides overall control to the portable terminal. For example, the controller 100 processes and controls voice telephony and data communication. According to an exemplary embodiment of the present invention, the controller 100 determines a function of an application for performing a network connection and then provides the function to a user in order to prevent a charging problem or a personal information leakage problem, and restricts execution of the application according to the function of the application.

In order to perform the aforementioned operation, the controller 100 performs an application installation process. The application installation process determines information including the function of the application that performs the network connection when the application is installed and stores and manages the information in the function information storage unit 106.

After performing the application installation process, the controller 100 provides a network connection function item of an application selected by the user based on pre-stored function information, so as to perform an execution restriction establishment process for allowing the user to determine whether to execute the application. In this case, the controller 100 stores information for reporting whether the application is executed to the execution information storage unit 108.

Upon detection of an application execution request, the controller 100 provides control such that the application is executed or the execution of the application is restricted according to information stored in the execution information storage unit 108. The controller 100 may also provide not only an item of a function that performs the network connection but also information for data used in the portable terminal (e.g., a read-only file, a write-only file, a read/write file, and the like) so as to prevent unnecessary file access of the user or other people.

The application configuration unit 102 performs the application installation process, the execution restriction establishment process, and the application execution process under the control of the controller 100.

The function determination unit 104 of the application configuration unit 102 determines a network connection function for performing an application selected by the user based on network connection function information of the application stored in the function information storage unit 106 when performing the execution restriction establishment process.

The function information storage unit 106 of the application configuration unit 102 stores the network connection function information of the application. The function information is generated when the application is installed.

The execution information storage unit 108 of the application configuration unit 102 stores information indicating whether to execute the application configured by the user of the portable terminal. The function information storage unit 106 and execution information storage unit 108 of the application configuration unit 102 may be included in the memory unit 110.

The memory unit 110 may include Read Only Memory (ROM), Random Access Memory (RAM), flash ROM and the like. The ROM stores a microcode of a program, by which the controller 100 and the application setup unit 102 are processed and controlled, and a variety of reference data. The RAM is a working memory of the controller 100 and stores temporary data that is generated while programs are performed. The flash ROM stores a variety of rewritable data, such as phonebook entries, outgoing messages, and incoming messages.

The input unit 112 includes a plurality of function keys such as numeral key buttons of ‘0’ to ‘9’, a menu button, a cancel button, an OK button, a talk button, an end button, an Internet access button, a navigation key button, a character input key and the like. Key input data (e.g., application selection), which is input when the user presses these keys, is provided to the controller 100.

The display unit 114 displays information including state information generated while the portable terminal operates, limited numeric characters, moving and still pictures, and the like. The display unit 114 may be a color Liquid Crystal Display (LCD), an Active Mode Organic Light Emitting Diode (AMOLED), and the like. The display unit 114 may include a touch input device as an input device when using a touch input type portable terminal.

The communication unit 116 transmits and receives a Radio Frequency (RF) signal of data that is input and output through an antenna (not illustrated). For example, in a transmitting process, data to be transmitted is subject to a channel-coding process and a spreading process, and then the data is transformed to an RF signal. In a receiving process, the RF signal is received and transformed to a base-band signal, and the base-band signal is subject to a de-spreading process and a channel-decoding process, thereby restoring the data.

Although the function of the application configuration unit 102 can be performed by the controller 100 of the portable terminal, these elements are described as separately constructed for exemplary purposes only. Those of ordinary skill in the art can understand that various modifications can be made within the scope of the present invention. For example, these elements may be constructed such that their functions are processed by the controller 100.

The exemplary embodiment of the present invention described above relates to an apparatus for determining a function performed when an application is executed in a portable terminal and for addressing a charging problem and personal information leakage problem undesired by the user when the application is executed. A method for addressing the charging problem and personal information leakage problem undesired by the user when the application is executed will be described based on the apparatus shown in FIG. 1.

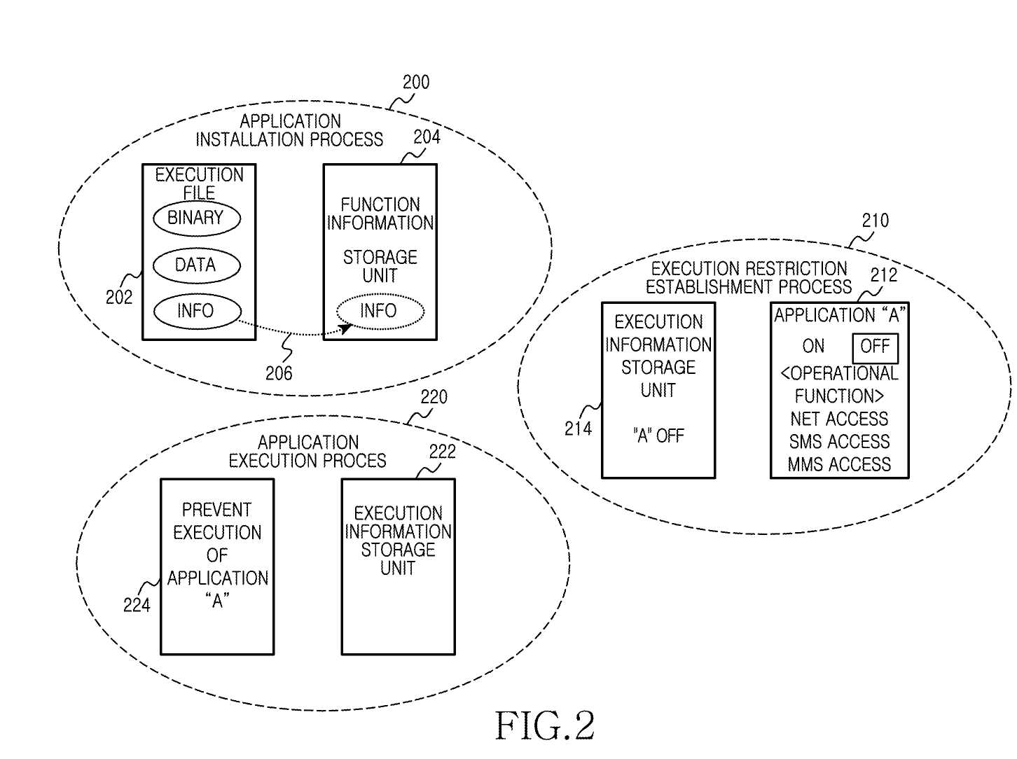

FIG. 2 illustrates a process of restricting execution of an application in a portable terminal according to an exemplary embodiment of the present invention.

Referring to FIG. 2, the portable terminal performs an application installation process 200, an execution restriction establishment process 210, and an application execution process 220.

The application installation process 200 is a process for installing an application desired by a user of the portable terminal. When installing the application, the portable terminal generates an execution file 202. The execution file 202 may include a binary file, a data file, and an info file. The binary file stores code necessary for execution of the application. The data file stores data necessary for execution of the application. The info file stores information related to the application. The information file includes all information (e.g., readable file information, writable file information, and the like) related to data used in a system (i.e., the portable terminal) including a network connection function performed when executing the application. The portable terminal manages the info file generated in the application installation process 200 by storing the information in a function information storage unit 204 (as indicated by 206 in FIG. 2).

The user of the portable terminal in which the application is installed can restrict the execution of the application pre-installed by the execution restriction establishment process 210. The reason for restricting the execution of the application is to prevent execution of the network connection function that causes charging or personal information leakage through the network connection function when the application is executed.

When performing the network connection function that causes the charging when the application is executed, the application (e.g., a game application) executed by the user may be used to access a network or to obtain or request specific information (e.g., ranking information) by using a short message. In addition, the network connection function uses information of the portable terminal, and transmits personal information to a corresponding network whenever the function is performed.

In order to address the aforementioned problem, the user of the portable terminal has to obtain and analyze data transmitted to the network and thus has to determine how and which network is used by a pre-installed application. However, general users cannot obtain or analyze the transmitted data. The general users cannot determine the network connection function unless a developer of the application intentionally uploads the application to a website for downloading the usage of the network.

According to an exemplary embodiment of the present invention, the network connection function of the application can be determined by determining the info file obtained in the application installation process. Information on the determined network connection function is provided to the user, thereby preventing the aforementioned problem. For example, the portable terminal identifies the info file stored in the function storage unit as illustrated in FIG. 2 and outputs an item (i.e., an operational function 212) for the network connection function performed in the application so as to allow the user to select whether to restrict the execution of the application.

If it is determined that the charging problem will occur since the user uses the item for the network connection function, the execution of the application is restricted (as indicated by the operational function 212) to avoid the charging problem. The portable terminal stores execution restriction information established by the user in an execution information storage unit 214 (in this case, an application “A” is off).

Thereafter, if the portable terminal performs the application execution process 220, the portable terminal determines whether the execution of the application to be executed by the user is restricted based on information stored in an execution information storage unit 222 as illustrated in FIG. 2. If the user determines that the execution-restricted application (i.e., an application for performing the network connection function and causing charging) is executed, the portable terminal performs a process 224 for preventing execution of the application.

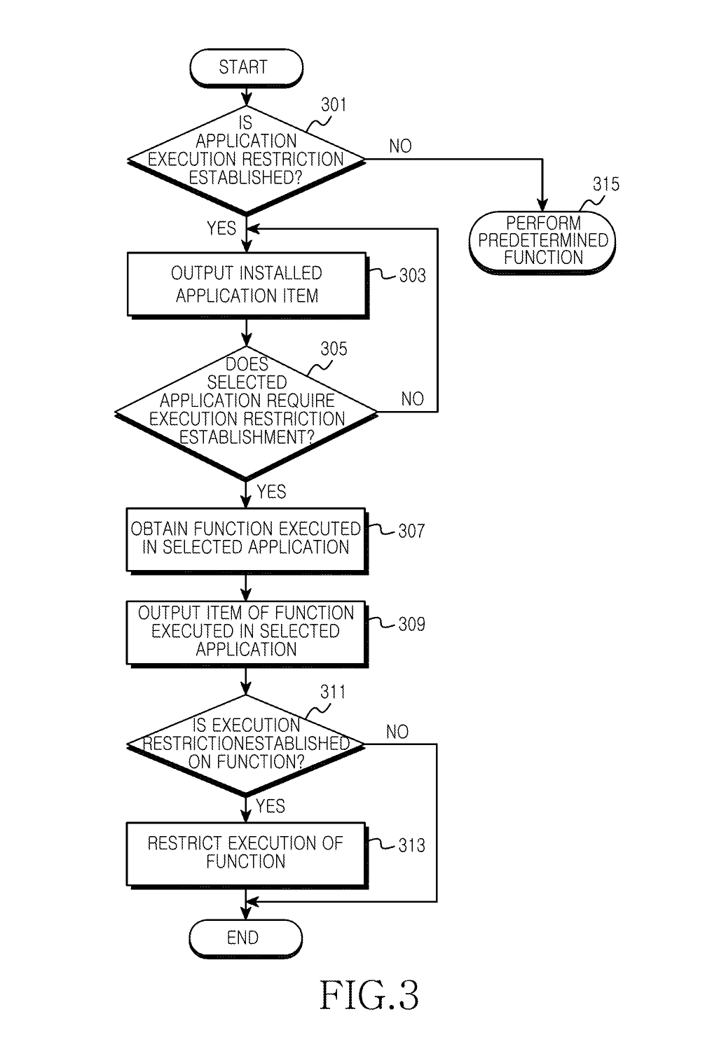

FIG. 3 is a flowchart illustrating a process of preventing execution of a charging-related function which is performed in an application downloaded and installed in a portable terminal according to an exemplary embodiment of the present invention.

Referring to FIG. 3, the portable terminal determines whether application execution restriction is established in step 301. One or more applications are installed in the portable terminal The application can perform a function corresponding to a network connection, such as a short message, a multimedia message, or network access, according to the design of a developer. When the application is executed in a situation where the user is not aware of a function of the pre-installed application, the portable terminal performs the network connection function via the application, thereby causing a charging problem. The establishment of the application execution restriction indicates that the execution of the application which may cause charging is restricted in order to address the aforementioned problem.

If the application execution restriction is not established in step 301, the portable terminal performs a predetermined function in step 315. The predetermined function may be, for example, a standby mode. Otherwise, if the application execution restriction is established in step 301, the portable terminal determines and outputs an item of the pre-installed application in step 303. The portable terminal determines in step 305 whether an application selected by the user of the portable terminal is an application which requires the execution restriction establishment. The user of the portable terminal can select any one or more applications which require the execution restriction establishment among the application items output in step 303.

If it is determined in step 305 that the user does not select an application which requires the execution restriction establishment, step 303 is repeated. Otherwise, if it is determined in step 305 that the user selects the application which requires the execution restriction establishment, the portable terminal obtains information on a function for performing the network connection in the application selected by the user in step 307.

According to an exemplary embodiment of the present invention, the portable terminal stores the information on the function for performing the network connection in a data format in the application when installing the application. For example, the portable terminal stores the information on the function for performing the application in an info file including a variety of information of the application. Accordingly, the portable terminal can obtain the function for performing the network connection in the application by determining the data-format information (i.e., the info file).

In step 309, the portable terminal outputs an item of the function for performing the network connection in the application selected by the user. Through this process, the user determines a function that causes charging among functions of the application and thus can address the charging problem occurring when the application is executed. In addition, in step 309, the portable terminal can prevent unnecessary file access of the user or other people by providing not only the item of the function for performing the network connection but also information on data used in the portable terminal (e.g., a read-only file, a write-only file, a read/write file, and the like.).

In step 311, the portable terminal determines whether to restrict the execution of the function output in step 309, i.e., the function that causes charging. If it is determined in step 311 that execution of the function that causes charging is not restricted, the portable terminal provides information on the function for performing the network connection in the application as described above. Otherwise, if it is determined in step 311 that the execution of the function that causes charging is restricted, the portable terminal establishes the restriction of the function execution and then stores related information in step 313. In order to prevent the execution of the function that causes charging through the network connection according to the present invention, the portable terminal may prevent the execution of the application in step 313.

According to the exemplary embodiment of the present invention described with respect to FIG. 3, the execution of the application including the function that causes charging through the network connection is restricted in order to prevent charging as an exemplary embodiment of the present invention. According to another exemplary embodiment of the present invention the execution of the application can be restricted in order to prevent leakage of personal information through a network connection function performed in the application.

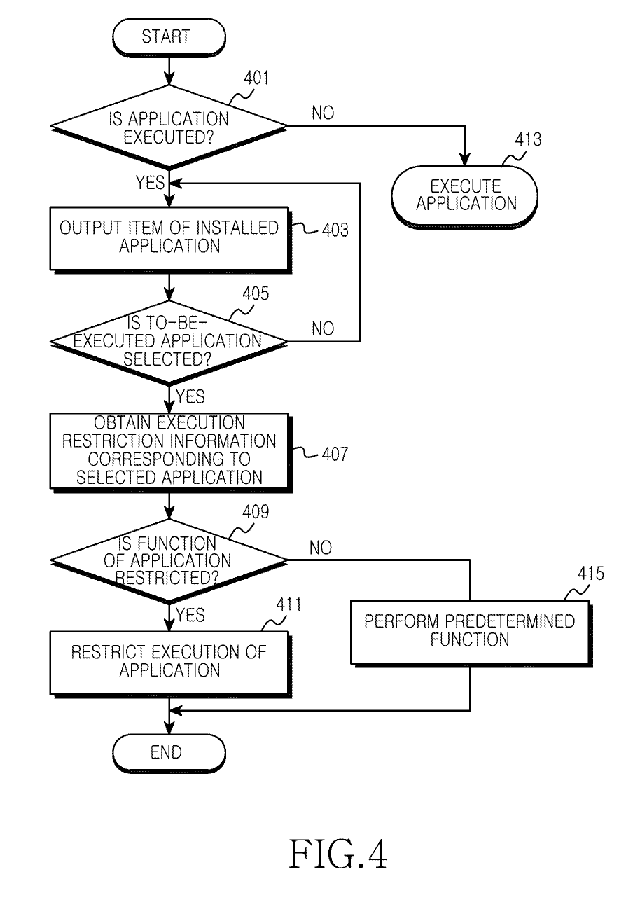

FIG. 4 is a flowchart illustrating a process of executing an application downloaded and installed in a portable terminal according to an exemplary embodiment of the present invention.

Referring to FIG. 4, the portable terminal determines whether an application execution request of a user is detected in step 401. If the application execution request is not detected in step 401, the portable terminal performs a predetermined function in step 413. The predetermined function may be, for example, a standby mode. Otherwise, if the application execution request is detected in step 401, the portable terminal outputs an item of a pre-installed application in step 403. The item may be, for example, an item of an executable application.

In step 405, the portable terminal determines whether the user selects an application intended to be executed. If the application intended to be executed is not selected in step 405, step 403 is repeated.

Otherwise, if the application intended to be executed is selected in step 405, the portable terminal obtains execution restriction information in step 407 corresponding to the application selected in step 405. In this case, the execution restriction information denotes information used to restrict execution of the application by the user when a function that causes charging is performed through a network connection at the execution of the application. The user of the portable terminal can establish the execution restriction information which prevents the execution of the application including the function that causes charging.

In step 409, the portable terminal determines whether the execution of the application intended to be executed by the user of the portable is restricted by using the execution restriction information obtained in step 407. If it is determined in step 409 that the execution of the function of the application is not restricted, the portable terminal executes the application in step 415. Otherwise, if it is determined in step 409 that the execution of the function of the application is restricted, the portable terminal disables the execution of the application in step 411.

According to exemplary embodiments of the present invention, information on an application pre-installed in a portable terminal is determined. When installing the application, information including a function of the application is generated, and information of the application that may cause charging is provided to a user by using the generated information, thereby addressing the conventional charging problem occurring when the application is executed in a situation not recognized by the user.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. An apparatus for preventing charging caused by the use of an application in a portable terminal, the apparatus comprising:
an application configuration unit for determining and storing function information of the application that performs a network connection, and for providing a network connection function item of the application selected by a user based on the pre-stored function information.

2. The apparatus of claim 1, wherein the application configuration unit provides the network connection function item of the application selected by the user and thereafter establishes execution restriction on the application such that the application is executed only when the user desires to execute the application.

3. The apparatus of claim 2, wherein, after the establishment of the execution restriction, the application configuration unit restricts the execution of the application based on pre-stored execution restriction information upon detection of an application execution request from the user.

4. The apparatus of claim 1, wherein the function information of the application that performs the network connection is included in a file in which information of the application is stored.

5. The apparatus of claim 4, wherein the function information of the application for performing the network connection includes at least one of network access, short message transmission, and multimedia message transmission.

6. The apparatus of claim 1, wherein the apparatus prevents leakage of personal information by using a network connection function of the application.

7. The apparatus of claim 1, wherein the application configuration unit provides not only the network connection function item but also information on data used in the portable terminal, and wherein the information on the data is information on data corresponding to any one of a read-only file, a write-only file, and a read/write file.

8. A method for preventing charging caused by the use of an application in a portable terminal, the method comprising:
determining and storing function information of the application that performs a network connection when the application is installed; and
providing a network connection function item of an application selected by a user based on the stored function information, after the determining and storing of the function information.

9. The method of claim 8, wherein the providing of the network connection function item further comprises establishing an execution restriction on the application such that the application is executed only when the user desires to execute the application, after providing the network connection function item of the application selected by the user.

10. The method of claim 9, further comprising:
restricting an execution of the application by using pre-stored execution restriction information upon detection of an application execution request, after the establishing of the execution restriction.

11. The method of claim 8, wherein the function information of the application that performs the network connection is included in a file in which information of the application is stored.

12. The method of claim 11, wherein the function information of the application for performing the network connection includes at least one of network access, short message transmission, and multimedia message transmission.

13. The method of claim 8, wherein the method prevents leakage of personal information by using a network connection function of the application.

14. The method of claim 8, wherein the providing of the network connection function item further comprises:
providing not only the network connection function item but also the information on the data used in the portable terminal, and
wherein the information on the data is information on data corresponding to any one of a read-only file, a write-only file, and a read/write file.

15. A mobile terminal, comprising:
a communication unit for communicating with a network;
a memory;
a controller for controlling execution of a function of an application stored in the mobile terminal based on network function information about the application; and
an application configuration unit for installing the application, for identifying the network function information of the application when the application is installed, and for storing the network function information in the memory.

16. The mobile terminal of claim 15, wherein the application configuration unit comprises a function determination unit for identifying the network function information of the application.

17. The mobile terminal of claim 15, further comprising:
a display unit to display a user interface via which a user may specify execution restriction information indicating when execution of the function of the application is to be restricted; and
an input unit for receiving the user's input,
wherein the application configuration unit stores the execution restriction information received from the user in the memory, and the controller refers to the execution restriction information when determining whether to restrict the execution of the function of the application.
